(19) United States
(12) Patent Application Publication
(10) Pub. No.: US 2025/0293715 A1
(43) Pub. Date: Sep. 18, 2025

(54) ANALOG FRONT END NON-LINEARITY MODEL ESTIMATION

(71) Applicant: QUALCOMM Incorporated, San Diego, CA (US)

(72) Inventors: Igor GUTMAN, Hod HaSharon (IL); Ajay Devadatta KANETKAR, San Diego, CA (US); Deekshith Raya VELGAPUNI, San Diego, CA (US); Tao LUO, San Diego, CA (US)

(21) Appl. No.: 18/608,752

(22) Filed: Mar. 18, 2024

(51) Int. Cl. H04B 1/04

(52) U.S. Cl. CPC H04B 1/04; H04B 2001/0433; H04B 2001/0441

(57) ABSTRACT

Methods, systems, and devices for wireless communications are described. The described techniques may enable a wireless device to determine a non-linearity (NL) model for a receiving analog front-end (RX AFE) of the wireless device in the presence of NL resulting from a transmitter used to transmit reference signals. The wireless device may determine the RX AFE NL by receiving a reference signal and processing the reference signal with a higher gain state (e.g., with low gain to result in a relatively lower RX AFE NL as compared to a lower gain state with high gain). The wireless device may accordingly separate the RX AFE NL and estimate the NL of the transmitter. The wireless device may receive and process a same reference signal via the RX AFE with a smaller gain state, and may use the processed reference signal and the estimated transmitter NL to estimate the RX AFE NL.

### FIELD OF TECHNOLOGY

The following relates to wireless communications, including analog front end non-linearity model estimation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support analog front end (AFE) non-linearity (NL) model estimation. For example, the described techniques may enable a wireless device to determine a NL model for both a receiving AFE of the wireless device and a transmitter of the wireless device used to transmit a reference signal. The wireless device may use a multi-step (e.g., two step) procedure to estimate the AFE NL. For example, in a first step, the wireless device may receive the reference signal and may process the reference signal via the AFE with a relatively high gain state (e.g., with low gain to result in a relatively lower AFE NL and higher noise as compared to a lower gain state with high gain). The wireless device may accordingly separate the transmitter NL and the AFE NL, and the wireless device may therefore estimate the NL of the transmitter. In a second step, the wireless device may receive and process a same reference signal via the receiving AFE with a relatively smaller gain state (e.g., a target gain state associated with a relatively larger NL than the higher gain state), and may use the processed reference signal and the estimated transmission NL to update the reference signal and estimate a NL model of the receiving AFE. The wireless device may use the estimated NL of the receiving AFE to improve reception and a signal-to-noise ratio (SNR) associated with received signals.

A method for wireless communications by a wireless device is described. The method may include receiving one or more reference signals associated with a transmission antenna element of the wireless device, performing a first NL estimation to obtain a first NL model associated with a transmitter of the wireless device based on receiving the one or more reference signals, the first NL estimation is based on a first gain state, and performing a second NL estimation to obtain a second NL model associated with a reception AFE of the wireless device based on the first NL model and a second gain state different than the first gain state, where the second NL model is used for a linearization of one or more signals.

A wireless device for wireless communications is described. The wireless device may include one or more memories storing processor executable code, and one or more processors coupled with the one or more memories. The one or more processors may individually or collectively be operable to execute the code to cause the wireless device to receive one or more reference signals associated with a transmission antenna element of the wireless device, perform a first NL estimation to obtain a first NL model associated with a transmitter of the wireless device based on receiving the one or more reference signals, the first NL estimation is based on a first gain state, and perform a second NL estimation to obtain a second NL model associated with a reception AFE of the wireless device based on the first NL model and a second gain state different than the first gain state, where the second NL model is used for a linearization of one or more signals.

Another wireless device for wireless communications is described. The wireless device may include means for receiving one or more reference signals associated with a transmission antenna element of the wireless device, means for performing a first NL estimation to obtain a first NL model associated with a transmitter of the wireless device based on receiving the one or more reference signals, the first NL estimation is based on a first gain state, and means for performing a second NL estimation to obtain a second NL model associated with a reception AFE of the wireless device based on the first NL model and a second gain state different than the first gain state, where the second NL model is used for a linearization of one or more signals.

A non-transitory computer-readable medium storing code for wireless communications is described. The code may include instructions executable by one or more processors to receive one or more reference signals associated with a transmission antenna element of the wireless device, perform a first NL estimation to obtain a first NL model associated with a transmitter of the wireless device based on receiving the one or more reference signals, the first NL estimation is based on a first gain state, and perform a second NL estimation to obtain a second NL model associated with a reception AFE of the wireless device based on the first NL model and a second gain state different than the first gain state, where the second NL model is used for a linearization of one or more signals.

Some examples of the method, wireless devices, and non-transitory computer-readable medium described herein may further include operations, features, means, or instructions for applying the first gain state when performing the first NL estimation, where the first gain state corresponds to a NL of the reception AFE that may be less than a NL threshold and applying the second gain state based on obtaining the first NL model associated with the transmitter.

In some examples of the method, wireless devices, and non-transitory computer-readable medium described herein, the second gain state may be associated with a second NL of the reception AFE, the second NL may be different than a first NL associated with the first gain state.

In some examples of the method, wireless devices, and non-transitory computer-readable medium described herein, the first NL model may be associated with an antenna array including the transmission antenna element, a power amplifier of the wireless device, or both.

In some examples of the method, wireless devices, and non-transitory computer-readable medium described herein, the second gain state may be a target gain state from a set of gain states.

Some examples of the method, wireless devices, and non-transitory computer-readable medium described herein may further include operations, features, means, or instructions for receiving the one or more signals via the reception AFE of the wireless device based on the target gain state and performing the linearization of the one or more signals based on the second NL model.

In some examples of the method, wireless devices, and non-transitory computer-readable medium described herein, a processing gain associated with the first NL estimation may be based on a signal to noise ratio corresponding to the first gain state.

In some examples of the method, wireless devices, and non-transitory computer-readable medium described herein, the first gain state and the second gain state include respective configurations of amplifiers associated with the reception AFE.

### BRIEF DESCRIPTION OF THE DRAWINGS

FIG. 1 shows an example of a wireless communications system that supports analog front end (AFE) non-linearity (NL) model estimation in accordance with one or more aspects of the present disclosure.

FIG. 2 shows an example of a wireless communications system that supports AFE NL model estimation in accordance with one or more aspects of the present disclosure.

FIG. 3 shows an example of a wireless communications system that supports AFE NL model estimation in accordance with one or more aspects of the present disclosure.

FIG. 4 shows an example of an NL estimation procedure that supports AFE NL model estimation in accordance with one or more aspects of the present disclosure.

FIGS. 5 and 6 show block diagrams of devices that support AFE NL model estimation in accordance with one or more aspects of the present disclosure.

FIG. 7 shows a block diagram of a communications manager that supports AFE NL model estimation in accordance with one or more aspects of the present disclosure.

FIG. 8 shows a diagram of a system including a device that supports AFE NL model estimation in accordance with one or more aspects of the present disclosure.

FIGS. 9 through 11 show flowcharts illustrating methods that support AFE NL model estimation in accordance with one or more aspects of the present disclosure.

### DETAILED DESCRIPTION

In some wireless communications systems, a wireless device may use a receiving analog front-end (AFE) component to receive an analog signal. The wireless device may perform one or more operations to process the analog signal (e.g., via a low-noise amplifier (LNA), a variable gain amplifier (VGA), phase shifters, and so on) and may perform an analog to digital conversion (ADC) to generate a digital signal via the receiving AFE (e.g., which may also be referred to as an RX AFE). Further, a digital front-end (DFE) of the device may perform a linearization and processing of the digital signal output by the AFE. In some examples, the AFE of the wireless device may have some non-linearity (NL) associated with the LNA, the VGA, or both. The wireless device may therefore use a model of the AFE NL to linearize the received signal via the DFE.

To generate the model of the AFE NL, the wireless device may transmit a reference signal from a transmitter of the wireless device to a receiver of the wireless device. The wireless device may process the reference signal using the AFE and may determine a NL of the processed reference signal. In some cases, however, the reference signal processed by the AFE may also have an NL associated with the transmitter of the wireless device. The wireless device may not distinguish between the NL of the AFE and the NL of the transmitter. Thus, performing an NL estimation of the AFE without knowledge of the NL associated with the transmitter may result in a relatively less accurate NL estimation of the AFE as compared to an AFE NL estimation using a transmitter NL model.

Accordingly, techniques described herein may allow for a wireless device to determine an NL model for both of a receiving AFE of the wireless device and a transmitter of the wireless device used to transmit a reference signal. For example, the wireless device may receive a reference signal from the transmitter and may process the reference signal via the AFE with a relatively high gain state (e.g., to result in a relatively lower NL associated with the AFE, as compared to NL associated with a lower gain state). The wireless device may accordingly estimate the NL of the transmitter. The wireless device may receive and process a same reference signal or a reference signal updated to account for the transmission NL via the receiving AFE with a relatively smaller gain state, and may use the processed reference signal (e.g., and the estimated transmitter NL) to estimate the NL of the receiving AFE. By performing a linearization of a received signal using the NL model of the AFE, the wireless device may reduce a signal-to-noise ratio (SNR) associated with the received signal, which may increase a quality of communications and a decrease a risk of retransmissions of a wireless communications system as compared to a system with a relatively larger SNR. By estimating both of the transmission NL and the AFE NL, the wireless device may reduce the SNR with relatively less processing than some other NL estimation techniques.

Aspects of the disclosure are initially described in the context of wireless communications systems. Aspects of the disclosure are further illustrated by and described with reference to NL estimation procedures, block diagrams, apparatus diagrams, system diagrams, and flowcharts that relate to AFE NL model estimation.

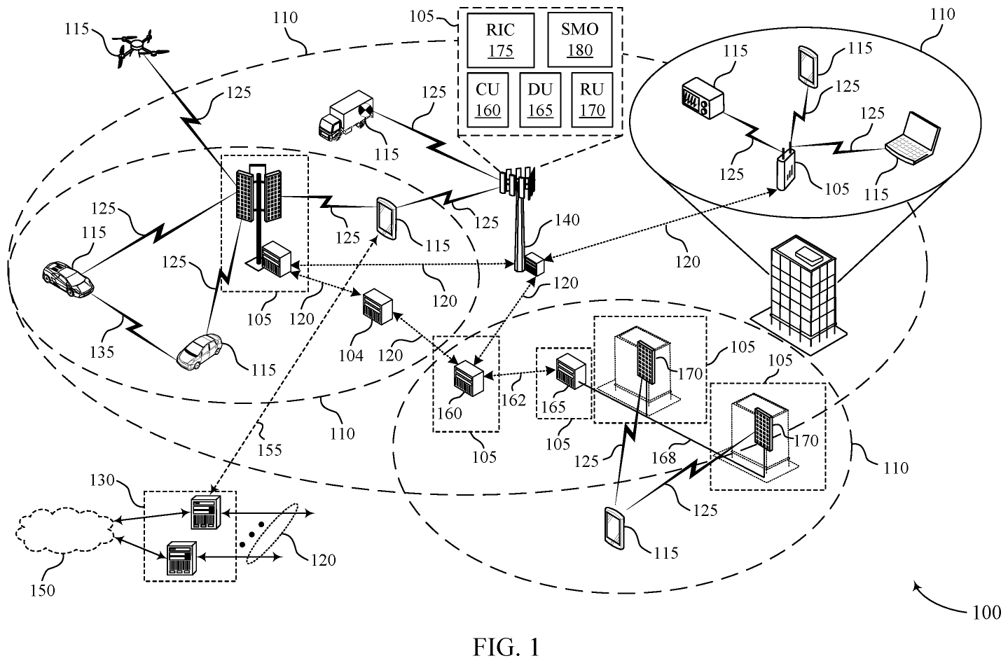

FIG. 1 shows an example of a wireless communications system 100 that supports AFE NL model estimation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

As described herein, a wireless device (e.g., a UE 115, a network entity 105) may determine an NL model for both of a receiving AFE (e.g., an RX AFE) of the wireless device and a transmitter of the wireless device used to transmit a reference signal. The wireless device may use a multi-step (e.g., two-step) procedure to estimate the AFE NL. For example, in a first step, the wireless device may receive the reference signal and may process the reference signal via the AFE with a relatively high gain state (e.g., with low gain to result in a relatively lower AFE NL and higher noise as compared to a lower gain state with high gain). The wireless device may accordingly separate (e.g., distinguish between) the transmitter NL and the AFE NL, and the wireless device may therefore estimate the NL of the transmitter. In a second step, the wireless device may receive and process a same reference signal via the receiving AFE with a relatively smaller gain state (e.g., a target gain state associated with a larger NL than the higher gain state), and may use the processed reference signal and the estimated transmission NL to update the reference signal and estimate a NL model of the receiving AFE.

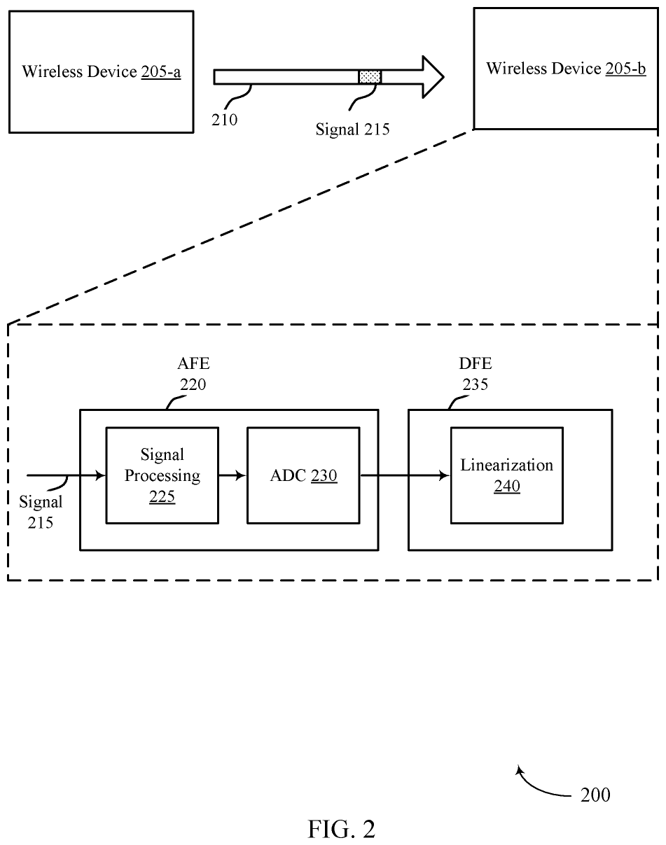

FIG. 2 shows an example of a wireless communications system 200 that supports AFE NL model estimation in accordance with one or more aspects of the present disclosure. The wireless communications system 200 may implement or may be implemented by aspects of the wireless communications system 100. For example, the wireless communications system 200 may be implemented by one or more wireless devices 205 (e.g., wireless device 205-a, wireless device 205-b), which may be examples of UEs 115 or network entities 105 as described herein with reference to FIG. 1.

In some examples of the wireless communications system 200, a wireless device 205-a may transmit a signal 215 to a wireless device 205-b (e.g., via a channel 210 between the wireless device 205-a and the wireless device 205-b). The wireless device 205-b may receive and process the signal 215 via receiving circuitry of the wireless device 205-b, including an AFE 220 and a DFE 235. The AFE 220 may be involved with processing the signal 215 via one or more amplifiers (e.g., a LNA and one or more VGAs). In some examples, the amplifiers may also include other components, such as phase shifters, combiners, mixers, or other components. The amplifiers may output a processed analog signal to an ADC 230, which may convert the analog signal to a digital signal and may output the digital signal to the DFE 235.

In some examples, an SNR associated with the signal 215 may be limited by various factors at the AFE 220. These factors may include thermal noise (e.g., evaluated using kTBFG, where k is the Boltzmann constant, T is a temperature in Kelvin, B is a signal channel bandwidth, F is a noise figure, and G is a total gain) of components within the AFE 220, NL (e.g., a third-order intermodulation (IM3)) of the components, which may be large for low-noise amplifiers), factors affecting the ADC 230 (e.g., integral NL, differential NL, quantization, jitter), and other factors. In some cases, such as those not limited by thermal noise, the SNR may be limited by the NL of the components of the AFE 220. This may result in a decreased SNR of the signal 215 as the wireless device 205-b processes the signal in a digital domain following the AFE 220 (e.g., via the DFE 235), which may result in decreased reception quality and may increase the risk of retransmissions.

In some examples, the AFE 220 may be associated with a gain state. The gain state may define a set of configurations (e.g., including one or more operational parameters) for a plurality of amplifiers of the wireless device 205-b (e.g., within a receive chain of the wireless device 205-b or within the AFE 220), such as the LNAs, the VGAs, and/or one or more other amplifiers. In some examples, the gain state may be selected by an automatic gain controller (AGC) based on reference signal power measurements (e.g., synchronization signal block (SSB) measurements, tracking reference signal (TRS) measurements). The reference signal power measurements may include external interference. In some cases, the gain state may affect the impact of different factors (e.g., thermal noise, NL) on an SNR of a received transmission. For example, a relatively higher gain state may result in a relatively smaller AFE NL, a relatively larger thermal noise, and a relatively lower SNR compared to cases where a lower gain state is used.

In some examples, the DFE 235 may perform a linearization 240 on the digital signal to remove a NL associated with the signal 215 (e.g., from a transmitter of the wireless device 205-a or from the one or more amplifiers of the AFE 220), which may increase a quality of communication of the signal 215 by increasing an SNR of the signal 215, therefore reducing retransmissions of the signal 215. To account for the NL of the AFE 220, the DFE 235 may use a model of the AFE NL when performing the linearization 240.

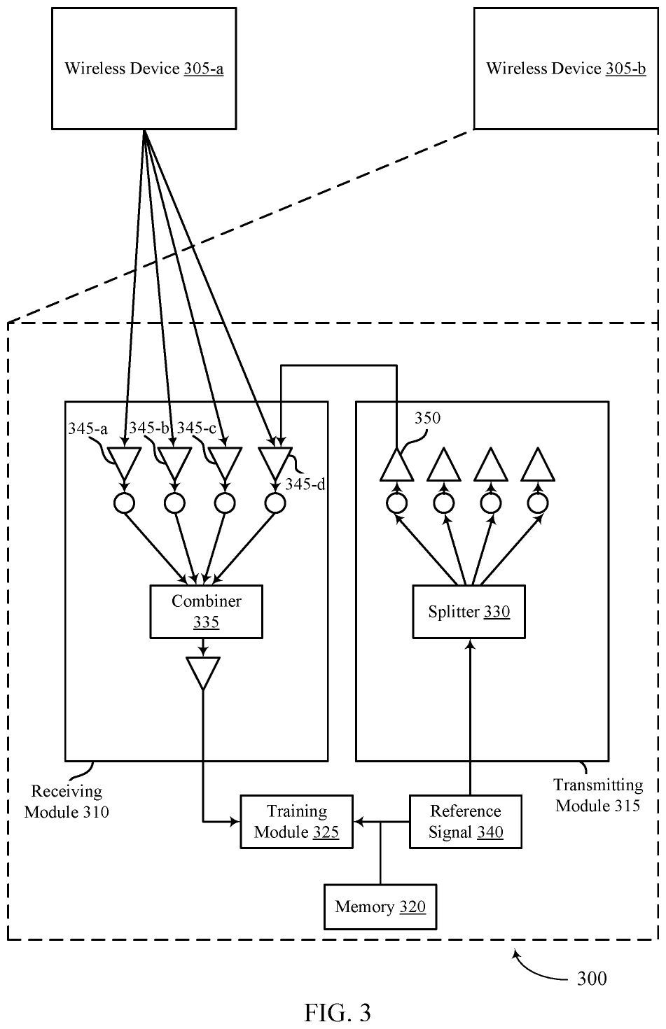

The wireless device 205-b may determine the AFE NL using an online or closed loop training approach. For example, the wireless device 205-b may transmit a reference signal from a transmitter of the wireless device 205-b and receiving and performing signal processing 225 on the reference signal via the AFE 220. Such techniques are described in further detail with reference to FIG. 3. In some examples, however, the transmitter of the wireless device 205-b may be associated with a NL, and the wireless device 205-b may not distinguish the AFE NL and the transmitter NL.

Accordingly, techniques described herein may enable the wireless device 205-b to estimate the transmitter NL and the AFE NL (e.g., using a multi-step estimation procedure). For example, the wireless device 205-b may estimate an NL model of the transmitter of the reference signal using a higher receiving gain state in which the AFE NL floor is relatively lower than a lower receiving gain state (e.g., below an NL threshold, less than 30 decibels below a main carrier power (dBc)). The wireless device 205-b may account for relatively higher thermal noise and therefore lower SNR associated with the higher gain state by performing a relatively longer training sequence (e.g., with higher processing gain).

The wireless device 205-b may estimate the AFE NL by retransmitting the reference signal (e.g., accounting for the transmitter NL using the estimated transmitter NL model before performing AFE NL estimation) and performing signal processing 225 on the retransmitted signal using a target gain state (e.g., a gain state for which the wireless device 205-b will determine the NL of the AFE 220). For example, the wireless device 205-b may update the reference signal to account for the transmitter NL, and may use the updated reference signal to estimate the NL of the receiving AFE 220. The wireless device 205-b may therefore use the AFE NL to perform linearization 240 via the DFE 235. Such techniques may enable a similar quality of linearization of signals 215 as an external training approach (e.g., in which the transmitter NL floor may be relatively smaller than the online training approach). Thus, the described NL estimation techniques may enable the wireless device 205-b to perform linearization 240 via the DFE 235, which may increase an effective dynamic range of the AFE 220.

FIG. 3 shows an example of a wireless communications system 300 that supports AFE NL model estimation in accordance with one or more aspects of the present disclosure. The wireless communications system 300 may implement or may be implemented by aspects of the wireless communications system 100 or the wireless communications system 200. For example, the wireless communications system 300 may be implemented by one or more wireless devices 305 (e.g., wireless device 305-a, wireless device 305-b), which may be examples of UEs 115 or network entities 105 as described herein with reference to FIG. 1 and/or the wireless devices 205-a and 205-b described herein with reference to FIG. 2.

In some examples, a wireless device 305-a may transmit one or more signals to a receiving module 310 of a wireless device 305-b (e.g., to a receiving antenna 345-a, a receiving antenna 345-b, a receiving antenna 345-c, a receiving antenna 345-d, and/or one or more additional receiving antennas 345). The wireless device 305-b may combine one or more received signals (e.g., a signal received at each receiving antenna 345) via a combiner 335. The wireless device 305-b may perform signal processing on the combined signal via an AFE of the wireless device 305-b, which may be associated with a NL. Accordingly, the wireless device 305-b may determine the NL of the AFE to perform a linearization of the processed signal (e.g., via a DFE) to reduce an SNF of the signal.

To determine the AFE NL, the wireless device 305-b may perform a closed-loop training approach. For example, the wireless device 305-b may generate a reference signal 340 (e.g., from a memory 320). The wireless device may transmit the reference signal 340 via a transmitting module 315 (e.g., through a splitter 330 and a single transmitting antenna 350) and may receive the reference signal via the receiving module 310 (e.g., at a single receiving antenna 345). The wireless device 305-b may not perform array-based training due to leakage between paired transmitting antennas 350 and receiving antennas 345 (e.g., leakage that may affect an NL of the reference signal 340 and therefore result in relatively less accurate NL estimations). The wireless device 305-b may therefore use a receiving antenna 345-d that has a response is relatively close to a response of the receiving module 310 (e.g., the array of receiving antennas 345) to receive the reference signal 340. The wireless device 305-b may use a transmitting antenna 350 that is unpaired with the receiving antenna 345-d to transmit the reference signal 340.

In some examples, post-combining signals via the combiner 335 may be a source of NL (e.g., a main source of NL) of the receiving module (e.g., the AFE). That is, a NL floor associated with an LNA of the wireless device 305-b may be relatively lower (e.g., less dominant) than a NL floor associated with one or more VGAs of the combiner 335. Accordingly, the wireless device 305-b may select an antenna element (e.g., the receiving antenna 345-d) that may have a NL response that is relatively closer to the NL response of the receiving antenna array than one or more other receiving antennas 345 (e.g., a “typical” receiving element). The wireless device 305-b may select the transmitting antenna 350 such that the transmitting antenna 350 is not coupled with the selected receiving antenna 345-d (e.g., to reduce leakage). However, the transmitting module 315 (e.g., the transmitting antenna 350) may also have a NL. That is, the reference signal 340 processed by the receiving module 310 may have a first NL associated with the transmitting module 315 (e.g., a transmitter NL) and a second NL associated with the receiving module 310 (e.g., the AFE NL).

Accordingly, to perform closed-loop training to model the AFE NL, the wireless device 305-b may perform a multi-step NL estimation procedure. That is, the wireless device 305-b may receive and process the reference signal 340 via the receiving module 310 (e.g., the AFE) using a first gain state. The first gain state may be associated with a relatively low NL (e.g., a NL below a threshold NL) and a relatively high SNR due to thermal noise. Accordingly, the wireless device 305-b may perform a relatively longer training sequence via a training module 325 to estimate a transmitter NL model. The wireless device 305-b may adjust or update the reference signal 340 using the transmitter NL model (e.g., to account to the transmitter NL) and retransmit the reference signal 340. The wireless device 305-b may receive and process the retransmitted reference signal 340 via the receiving module 310 using a second gain state (e.g., a target gain state) that is relatively lower than the first gain state. The second gain state may therefore be associated with a relatively high NL (e.g., a NL above the threshold NL) and a relatively lower SNR than the first gain state due to lower thermal noise. Accordingly, the wireless device 305-b may estimate the AFE NL (e.g., via the training module 325). The wireless device 305-b may estimate the transmitter NL and the AFE NL by comparing the received and processed reference signal 340 with the reference signal 340 stored in the memory 320 (e.g., an un-transmitted and un-processed reference signal 340).

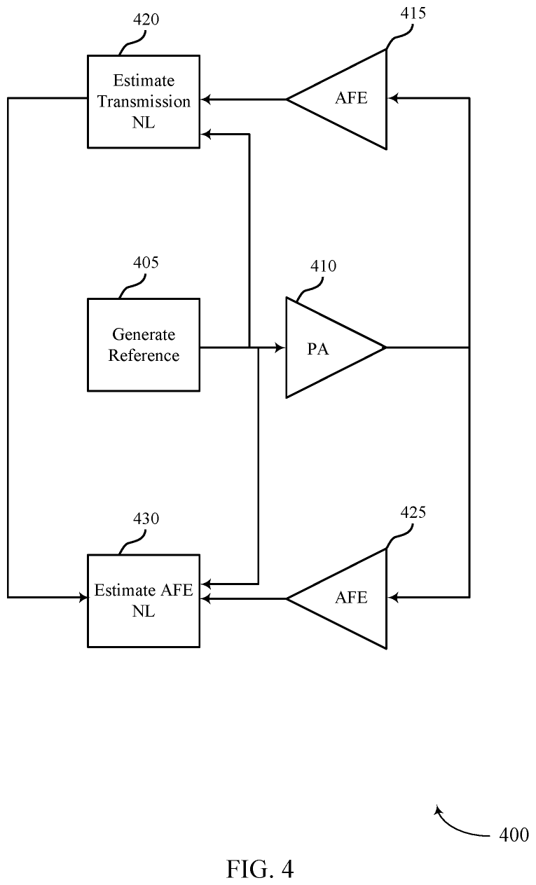

FIG. 4 shows an example of an NL estimation procedure 400 that supports AFE NL model estimation in accordance with one or more aspects of the present disclosure. The NL estimation procedure 400 may implement or may be implemented by aspects of the wireless communications system 100, the wireless communications system 200, or the wireless communications system 300. For example, the NL estimation procedure 400 may be implemented by one or more wireless devices, which may be examples of UEs 115 or network entities 105 as described herein with reference to FIG. 1, the wireless devices 205-a or 205-b as described herein with reference to FIG. 2, and/or the wireless devices 305-a or 305-b as described herein with reference to FIG. 3.

At 405, a wireless device may generate one or more reference signals. The one or more reference signals may be stored in a memory of the wireless device. As an illustrative example, the one or more reference signals may be a function such as y=x. The one or more reference signals may be one or more other functions.

At 410, the wireless device may transmit a first reference signal from a transmission antenna element of the wireless device to a receiving antenna element of the wireless device (e.g., a receiving antenna element that is uncoupled with the transmission antenna element). The wireless device may use a transmitting antenna array including one or more power amplifiers (PAs) to amplify the first reference signal. One or both of the PAs or the transmission antenna element of the transmitting antenna array may be associated with a transmission NL. Accordingly, the first reference signal received by the receiving antenna element of the wireless device may be a function y=PA(x)*h (e.g., where h is a channel between the transmission antenna element and PA is a NL function associated with the transmission NL of one or both of the PAs or the transmission antenna element of the transmitting antenna array).

At 415, the wireless device may receive and process the received reference signal using a receiving AFE of the wireless device. For example, the wireless device may process the received reference signal by applying a relatively high receiving AFE gain state (e.g., a receiving AFE gain state that is greater than a target receiving AFE gain state of the set of receiving AFE gain states), which may be associated with a receiving AFE NL that is below a NL threshold. The relatively high receiving AFE gain state and the target receiving AFE gain state (e.g., and one or more other receiving AFE gain states of the set of receiving AFE gain states) may be respective configurations of amplifiers (e.g., LNAs, VGAs) of the receiving AFE. The processed received reference signal may be of a form z=PA(x)*h+n₁, where n₁ may be a noise function associated with processing the received reference signal with the relatively high receiving AFE gain state (e.g., thermal noise).

At 420, the wireless device may perform a first NL estimation using the received and processed reference signal to obtain an estimated transmission NL model associated with the transmitting antenna array (e.g., the PAs or the transmitting antenna element). That is, the wireless device may estimate PA based on the transmitted reference signal y=x and based on assuming a relatively low receiving AFE NL (e.g., below the NL threshold). In some examples, a processing gain (e.g., a length of a training sequence) associated with estimating the transmission NL model may be based on a SNR associated with the relatively high receiving AFE gain state. That is, the wireless device may perform a relatively long training sequence to account for the thermal noise and therefore SNR associated with using the relatively high receiving AFE gain state.

The wireless device may generate and transmit one or more additional reference signals. For example, the wireless device may retransmit the first reference signal of the form y=x. In some examples, the wireless device may update or adjust the one or more additional reference signals to account for the estimated transmission NL (e.g., using the estimated transmission NL model). That is, the wireless device may apply an inverse NL function of the estimated transmission NL function. The wireless device may transmit the one or more additional reference signals via the transmitting antenna array (e.g., the transmitting antenna element and the one or more PAs).

At 425, the wireless device may receive and process a second reference signal (e.g., of the one or more additional reference signals) via the receiving AFE by applying a receiving AFE gain state that is lower than the high receiving AFE gain state (e.g., with the target receiving AFE gain state). The wireless device may apply the target AFE gain state based on obtaining the transmission NL model. The target AFE gain state may be associated with a different (e.g., relatively higher) NL than the high receiving AFE gain state.

In some examples (e.g., if the wireless device retransmits the first reference signal), the received second reference signal may be of the form y=PA(x)*h, and the processed second reference signal may be of the form z=AFE(PA(x))*h+n₂. In some examples (e.g., if the wireless device adjusts the one or more additional reference signals based on the estimated transmission NL model), the received second reference signal may be of the form y=x*h and the processed reference signal may be of the form z=AFE(x)*h+n₂. In such examples, AFE may be a NL of the receiving AFE and n₂ may be a noise function associated with processing the received reference signal with the target receiving AFE gain state (e.g., thermal noise). n₂ may be lower than n₁ (e.g., due to the target receiving AFE gain state being lower than the high receiving AFE gain state).

At 430, the wireless device may perform a second NL estimation using the received and processed second reference signal to obtain an estimated receiving AFE NL model associated with the receiving AFE (e.g., the LNAs and/or the VGAs). That is, the wireless device may estimate AFE based on the transmitted second reference signal and based on the estimated transmission NL model PA.

Accordingly, the wireless device may receive one or more signals (e.g., from a second wireless device), and may process the one or more signals via the receiving AFE and a DFE of the wireless device. For example, the wireless device may perform a linearization of the one or more signals via the DFE based on the estimated receiving AFE NL model.

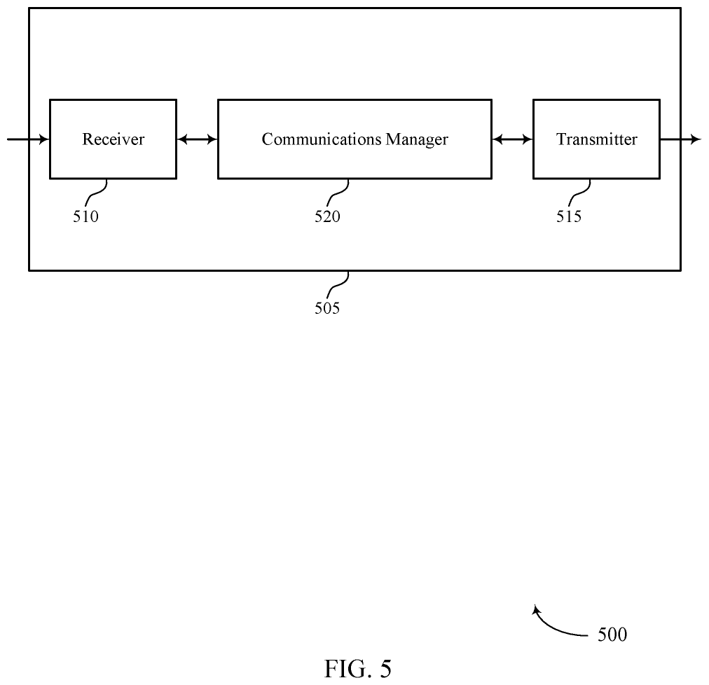

FIG. 5 shows a block diagram 500 of a device 505 that supports AFE NL model estimation in accordance with one or more aspects of the present disclosure. The device 505 may be an example of aspects of a wireless device (e.g., a UE 115, a network entity 105) as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to AFE NL model estimation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to AFE NL model estimation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of AFE NL model estimation as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving one or more reference signals associated with a transmission antenna element of the wireless device. The communications manager 520 is capable of, configured to, or operable to support a means for performing a first NL estimation to obtain a first NL model associated with a transmitter of the wireless device based on receiving the one or more reference signals, the first NL estimation is based on a first gain state. The communications manager 520 is capable of, configured to, or operable to support a means for performing a second NL estimation to obtain a second NL model associated with a reception AFE of the wireless device based on the first NL model and a second gain state different than the first gain state, where the second NL model is used for a linearization of one or more signals.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for estimating a transmission NL and an AFE NL, which may result in reduced processing.

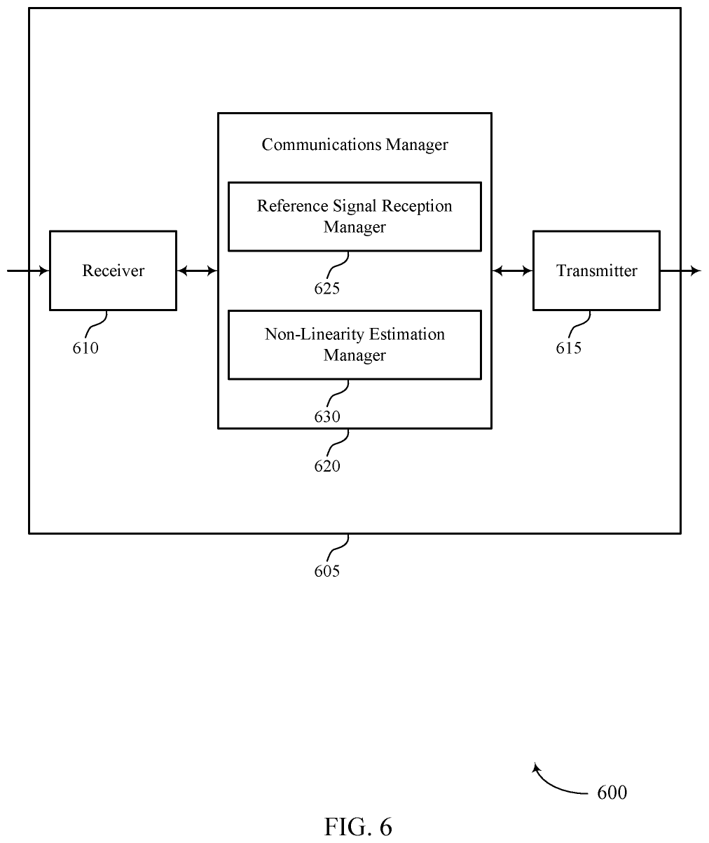

FIG. 6 shows a block diagram 600 of a device 605 that supports AFE NL model estimation in accordance with one or more aspects of the present disclosure. The device 605 may be an example of aspects of a device 505 or a wireless device as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to AFE NL model estimation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to AFE NL model estimation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of AFE NL model estimation as described herein. For example, the communications manager 620 may include a reference signal reception manager 625 a NL estimation manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The reference signal reception manager 625 is capable of, configured to, or operable to support a means for receiving one or more reference signals associated with a transmission antenna element of the wireless device. The NL estimation manager 630 is capable of, configured to, or operable to support a means for performing a first NL estimation to obtain a first NL model associated with a transmitter of the wireless device based on receiving the one or more reference signals, the first NL estimation is based on a first gain state. The NL estimation manager 630 is capable of, configured to, or operable to support a means for performing a second NL estimation to obtain a second NL model associated with a reception AFE of the wireless device based on the first NL model and a second gain state different than the first gain state, where the second NL model is used for a linearization of one or more signals.

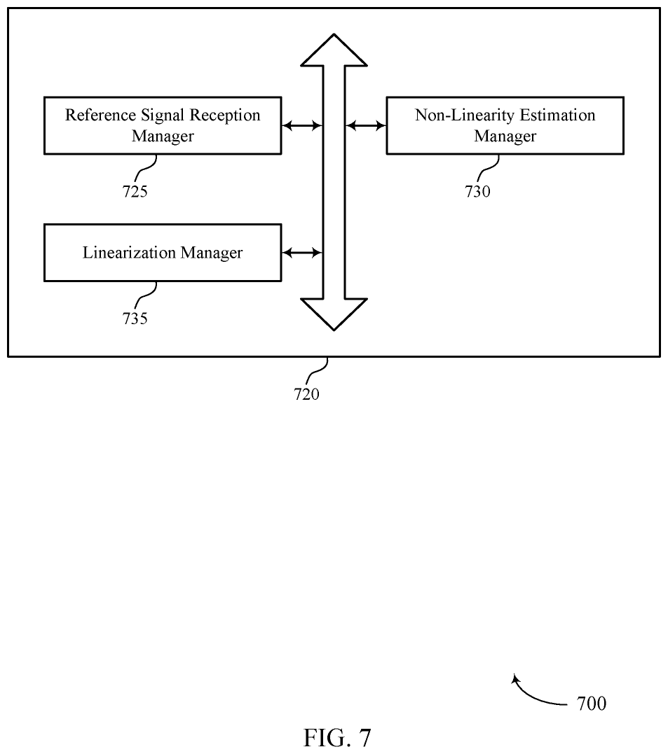

FIG. 7 shows a block diagram 700 of a communications manager 720 that supports AFE NL model estimation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of AFE NL model estimation as described herein. For example, the communications manager 720 may include a reference signal reception manager 725, a NL estimation manager 730, a linearization manager 735, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The reference signal reception manager 725 is capable of, configured to, or operable to support a means for receiving one or more reference signals associated with a transmission antenna element of the wireless device. The NL estimation manager 730 is capable of, configured to, or operable to support a means for performing a first NL estimation to obtain a first NL model associated with a transmitter of the wireless device based on receiving the one or more reference signals, the first NL estimation is based on a first gain state. In some examples, the NL estimation manager 730 is capable of, configured to, or operable to support a means for performing a second NL estimation to obtain a second NL model associated with a reception AFE of the wireless device based on the first NL model and a second gain state different than the first gain state, where the second NL model is used for a linearization of one or more signals.

In some examples, the NL estimation manager 730 is capable of, configured to, or operable to support a means for applying the first gain state when performing the first NL estimation, where the first gain state corresponds to a NL of the reception AFE that is less than a NL threshold. In some examples, the NL estimation manager 730 is capable of, configured to, or operable to support a means for applying the second gain state based on obtaining the first NL model associated with the transmitter.

In some examples, the second gain state is associated with a second NL of the reception AFE, the second NL is different than a first NL associated with the first gain state. In some examples, the first NL model is associated with an antenna array including the transmission antenna element, a power amplifier of the wireless device, or both. In some examples, the second gain state is a target gain state from a set of gain states.

In some examples, the reference signal reception manager 725 is capable of, configured to, or operable to support a means for receiving the one or more signals via the reception AFE of the wireless device based on the target gain state. In some examples, the linearization manager 735 is capable of, configured to, or operable to support a means for performing the linearization of the one or more signals based on the second NL model.

In some examples, a processing gain associated with the first NL estimation is based on a signal to noise ratio corresponding to the first gain state. In some examples, the first gain state and the second gain state include respective configurations of amplifiers associated with the reception AFE.

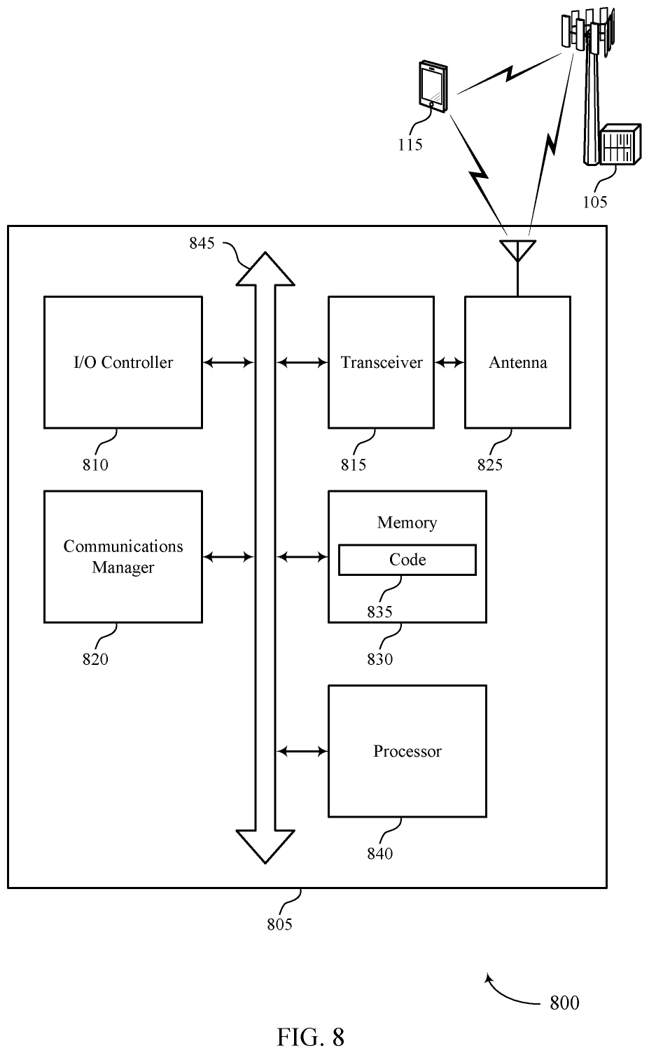

FIG. 8 shows a diagram of a system 800 including a device 805 that supports AFE NL model estimation in accordance with one or more aspects of the present disclosure. The device 805 may be an example of or include components of a device 505, a device 605, or a wireless device (e.g., a UE 115, a network entity 105) as described herein. The device 805 may include components for bi-directional voice and data communications including components for transmitting and receiving communications, such as a communications manager 820, an I/O controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include RAM and ROM. The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a BIOS which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting AFE NL model estimation). For example, the device 805 or a component of the device 805 may include at least one processor 840 and at least one memory 830 coupled with or to the at least one processor 840, the at least one processor 840 and the at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving one or more reference signals associated with a transmission antenna element of the wireless device. The communications manager 820 is capable of, configured to, or operable to support a means for performing a first NL estimation to obtain a first NL model associated with a transmitter of the wireless device based on receiving the one or more reference signals, the first NL estimation is based on a first gain state. The communications manager 820 is capable of, configured to, or operable to support a means for performing a second NL estimation to obtain a second NL model associated with a reception AFE of the wireless device based on the first NL model and a second gain state different than the first gain state, where the second NL model is used for a linearization of one or more signals.

By including or configuring the communications manager 820 in accordance with examples as described herein, the device 805 may support techniques for estimating a transmission NL and an AFE NL, which may result in improved communication reliability, improved user experience related to reduced processing, reduced power consumption, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of AFE NL model estimation as described herein, or the at least one processor 840 and the at least one memory 830 may be otherwise configured to, individually or collectively, perform or support such operations.

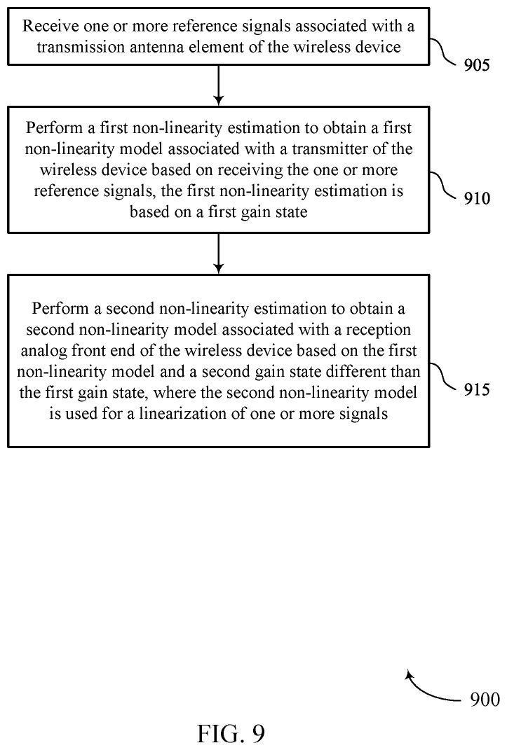

FIG. 9 shows a flowchart illustrating a method 900 that supports AFE NL model estimation in accordance with one or more aspects of the present disclosure. The operations of the method 900 may be implemented by a wireless device or its components as described herein. For example, the operations of the method 900 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 905, the method may include receiving one or more reference signals associated with a transmission antenna element of the wireless device. The operations of 905 may be performed in accordance with examples as disclosed herein. In some examples, aspects of the operations of 905 may be performed by a reference signal reception manager 725 as described with reference to FIG. 7.

At 910, the method may include performing a first NL estimation to obtain a first NL model associated with a transmitter of the wireless device based on receiving the one or more reference signals, the first NL estimation is based on a first gain state. The operations of 910 may be performed in accordance with examples as disclosed herein. In some examples, aspects of the operations of 910 may be performed by a NL estimation manager 730 as described with reference to FIG. 7.

At 915, the method may include performing a second NL estimation to obtain a second NL model associated with a reception AFE of the wireless device based on the first NL model and a second gain state different than the first gain state, where the second NL model is used for a linearization of one or more signals. The operations of 915 may be performed in accordance with examples as disclosed herein. In some examples, aspects of the operations of 915 may be performed by a NL estimation manager 730 as described with reference to FIG. 7.

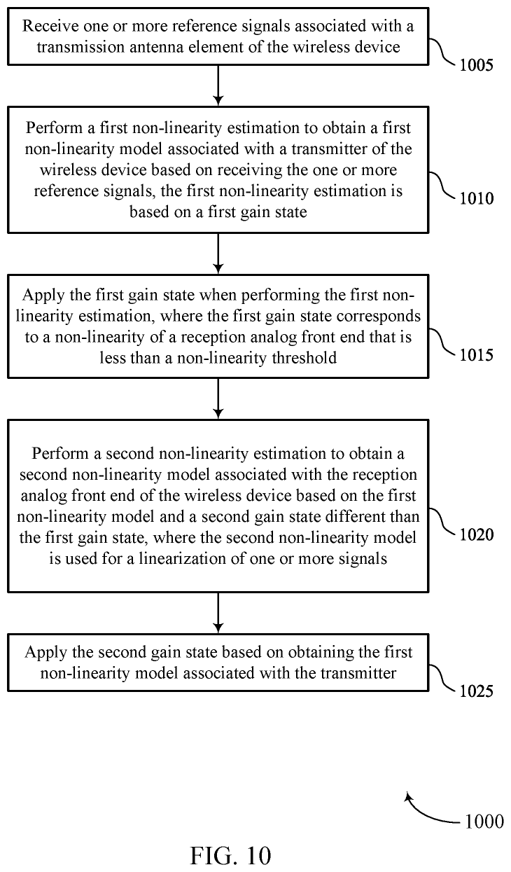

FIG. 10 shows a flowchart illustrating a method 1000 that supports AFE NL model estimation in accordance with one or more aspects of the present disclosure. The operations of the method 1000 may be implemented by a wireless device or its components as described herein. For example, the operations of the method 1000 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1005, the method may include receiving one or more reference signals associated with a transmission antenna element of the wireless device. The operations of 1005 may be performed in accordance with examples as disclosed herein. In some examples, aspects of the operations of 1005 may be performed by a reference signal reception manager 725 as described with reference to FIG. 7.

At 1010, the method may include performing a first NL estimation to obtain a first NL model associated with a transmitter of the wireless device based on receiving the one or more reference signals, the first NL estimation is based on a first gain state. The operations of 1010 may be performed in accordance with examples as disclosed herein. In some examples, aspects of the operations of 1010 may be performed by a NL estimation manager 730 as described with reference to FIG. 7.

At 1015, the method may include applying the first gain state when performing the first NL estimation, where the first gain state corresponds to a NL of an reception AFE that is less than a NL threshold. The operations of 1015 may be performed in accordance with examples as disclosed herein. In some examples, aspects of the operations of 1015 may be performed by a NL estimation manager 730 as described with reference to FIG. 7.

At 1020, the method may include performing a second NL estimation to obtain a second NL model associated with the reception AFE of the wireless device based on the first NL model and a second gain state different than the first gain state, where the second NL model is used for a linearization of one or more signals. The operations of 1020 may be performed in accordance with examples as disclosed herein. In some examples, aspects of the operations of 1020 may be performed by a NL estimation manager 730 as described with reference to FIG. 7.

At 1025, the method may include applying the second gain state based on obtaining the first NL model associated with the transmitter. The operations of 1025 may be performed in accordance with examples as disclosed herein. In some examples, aspects of the operations of 1025 may be performed by a NL estimation manager 730 as described with reference to FIG. 7.

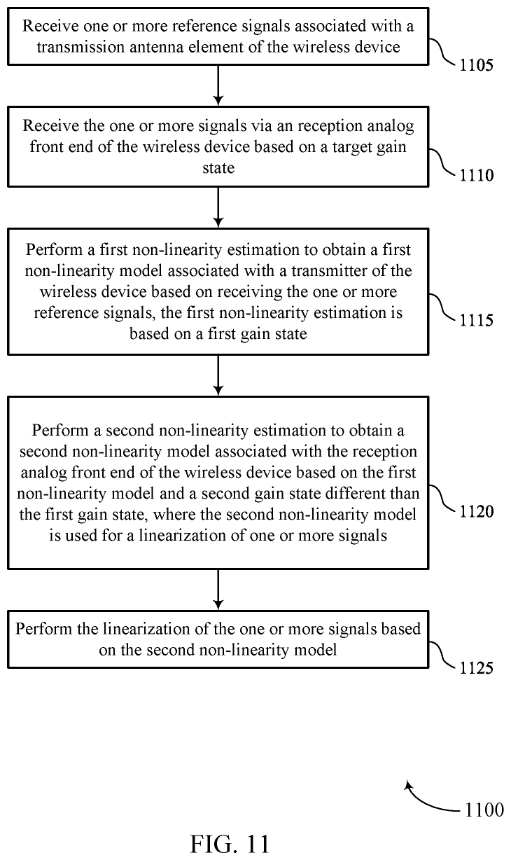

FIG. 11 shows a flowchart illustrating a method 1100 that supports AFE NL model estimation in accordance with one or more aspects of the present disclosure. The operations of the method 1100 may be implemented by a wireless device or its components as described herein. For example, the operations of the method 1100 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1105, the method may include receiving one or more reference signals associated with a transmission antenna element of the wireless device. The operations of 1105 may be performed in accordance with examples as disclosed herein. In some examples, aspects of the operations of 1105 may be performed by a reference signal reception manager 725 as described with reference to FIG. 7.

At 1110, the method may include receiving the one or more signals via an reception AFE of the wireless device based on a target gain state. The operations of 1110 may be performed in accordance with examples as disclosed herein. In some examples, aspects of the operations of 1110 may be performed by a reference signal reception manager 725 as described with reference to FIG. 7.

At 1115, the method may include performing a first NL estimation to obtain a first NL model associated with a transmitter of the wireless device based on receiving the one or more reference signals, the first NL estimation is based on a first gain state. The operations of 1115 may be performed in accordance with examples as disclosed herein. In some examples, aspects of the operations of 1115 may be performed by a NL estimation manager 730 as described with reference to FIG. 7.

At 1120, the method may include performing a second NL estimation to obtain a second NL model associated with the reception AFE of the wireless device based on the first NL model and a second gain state different than the first gain state, where the second NL model is used for a linearization of one or more signals. The operations of 1120 may be performed in accordance with examples as disclosed herein. In some examples, aspects of the operations of 1120 may be performed by a NL estimation manager 730 as described with reference to FIG. 7.

At 1125, the method may include performing the linearization of the one or more signals based on the second NL model. The operations of 1125 may be performed in accordance with examples as disclosed herein. In some examples, aspects of the operations of 1125 may be performed by a linearization manager 735 as described with reference to FIG. 7.

The following provides an overview of aspects of the present disclosure:

Aspect 1: A method for wireless communications by a wireless device, comprising: receiving one or more reference signals associated with a transmission antenna element of the wireless device; performing a first NL estimation to obtain a first NL model associated with a transmitter of the wireless device based at least in part on receiving the one or more reference signals, the first NL estimation is based at least in part on a first gain state; and performing a second NL estimation to obtain a second NL model associated with a reception AFE of the wireless device based at least in part on the first NL model and a second gain state different than the first gain state, wherein the second NL model is used for a linearization of one or more signals.

Aspect 2: The method of aspect 1, further comprising: applying the first gain state when performing the first NL estimation, wherein the first gain state corresponds to a NL of the reception AFE that is less than a NL threshold; and applying the second gain state based at least in part on obtaining the first NL model associated with the transmitter.

Aspect 3: The method of any of aspects 1 through 2, wherein the second gain state is associated with a second NL of the reception AFE, the second NL is different than a first NL associated with the first gain state.

Aspect 4: The method of any of aspects 1 through 3, wherein the first NL model is associated with an antenna array including the transmission antenna element, a PA of the wireless device, or both.

Aspect 5: The method of any of aspects 1 through 4, wherein the second gain state is a target gain state from a set of gain states.

Aspect 6: The method of aspect 5, further comprising: receiving the one or more signals via the reception AFE of the wireless device based at least in part on the target gain state; and performing the linearization of the one or more signals based at least in part on the second NL model.

Aspect 7: The method of any of aspects 1 through 6, wherein a processing gain associated with the first NL estimation is based at least in part on a signal to noise ratio corresponding to the first gain state.

Aspect 8: The method of any of aspects 1 through 7, wherein the first gain state and the second gain state comprise respective configurations of amplifiers associated with the reception AFE.

Aspect 9: A wireless device for wireless communications, comprising one or more memories storing processor-executable code, and one or more processors coupled with the one or more memories and individually or collectively operable to execute the code to cause the wireless device to perform a method of any of aspects 1 through 8.

Aspect 10: A wireless device for wireless communications, comprising at least one means for performing a method of any of aspects 1 through 8.

Aspect 11: A non-transitory computer-readable medium storing code for wireless communications, the code comprising instructions executable by one or more processors to perform a method of any of aspects 1 through 8.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
receive one or more reference signals associated with a transmission antenna element of the wireless device;
perform a first non-linearity estimation to obtain a first non-linearity model associated with a transmitter of the wireless device based at least in part on receiving the one or more reference signals, the first non-linearity estimation is based at least in part on a first gain state; and
perform a second non-linearity estimation to obtain a second non-linearity model associated with a reception analog front end of the wireless device based at least in part on the first non-linearity model and a second gain state different than the first gain state, wherein the second non-linearity model is used for a linearization of one or more signals.

2. The wireless device of claim 1, wherein the one or more processors are individually or collectively further operable to execute the code to cause the wireless device to:
apply the first gain state when performing the first non-linearity estimation, wherein the first gain state corresponds to a non-linearity of the reception analog front end that is less than a non-linearity threshold; and
apply the second gain state based at least in part on obtaining the first non-linearity model associated with the transmitter.

3. The wireless device of claim 1, wherein the second gain state is associated with a second non-linearity of the reception analog front end, the second non-linearity is different than a first non-linearity associated with the first gain state.

4. The wireless device of claim 1, wherein the first non-linearity model is associated with an antenna array including the transmission antenna element, a power amplifier of the wireless device, or both.

5. The wireless device of claim 1, wherein the second gain state is a target gain state from a set of gain states.

6. The wireless device of claim 5, wherein the one or more processors are individually or collectively further operable to execute the code to cause the wireless device to:
receive the one or more signals via the reception analog front end of the wireless device based at least in part on the target gain state; and
perform the linearization of the one or more signals based at least in part on the second non-linearity model.

7. The wireless device of claim 1, wherein a processing gain associated with the first non-linearity estimation is based at least in part on a signal to noise ratio corresponding to the first gain state.

8. The wireless device of claim 1, wherein the first gain state and the second gain state comprise respective configurations of amplifiers associated with the reception analog front end.

9. A method for wireless communications by a wireless device, comprising:
receiving one or more reference signals associated with a transmission antenna element of the wireless device;
performing a first non-linearity estimation to obtain a first non-linearity model associated with a transmitter of the wireless device based at least in part on receiving the one or more reference signals, the first non-linearity estimation is based at least in part on a first gain state; and
performing a second non-linearity estimation to obtain a second non-linearity model associated with a reception analog front end of the wireless device based at least in part on the first non-linearity model and a second gain state different than the first gain state, wherein the second non-linearity model is used for a linearization of one or more signals.

10. The method of claim 9, further comprising:
applying the first gain state when performing the first non-linearity estimation, wherein the first gain state corresponds to a non-linearity of the reception analog front end that is less than a non-linearity threshold; and
applying the second gain state based at least in part on obtaining the first non-linearity model associated with the transmitter.

11. The method of claim 9, wherein the second gain state is associated with a second non-linearity of the reception analog front end, the second non-linearity is different than a first non-linearity associated with the first gain state.

12. The method of claim 9, wherein the first non-linearity model is associated with an antenna array including the transmission antenna element, a power amplifier of the wireless device, or both.

13. The method of claim 9, wherein the second gain state is a target gain state from a set of gain states.

14. The method of claim 13, further comprising:
receiving the one or more signals via the reception analog front end of the wireless device based at least in part on the target gain state; and
performing the linearization of the one or more signals based at least in part on the second non-linearity model.

15. The method of claim 9, wherein a processing gain associated with the first non-linearity estimation is based at least in part on a signal to noise ratio corresponding to the first gain state.

16. The method of claim 9, wherein the first gain state and the second gain state comprise respective configurations of amplifiers associated with the reception analog front end.

17. A wireless device for wireless communications, comprising:
means for receiving one or more reference signals associated with a transmission antenna element of the wireless device;
means for performing a first non-linearity estimation to obtain a first non-linearity model associated with a transmitter of the wireless device based at least in part on receiving the one or more reference signals, the first non-linearity estimation is based at least in part on a first gain state; and
means for performing a second non-linearity estimation to obtain a second non-linearity model associated with a reception analog front end of the wireless device based at least in part on the first non-linearity model and a second gain state different than the first gain state, wherein the second non-linearity model is used for a linearization of one or more signals.

18. The wireless device of claim 17, further comprising:
means for applying the first gain state when performing the first non-linearity estimation, wherein the first gain state corresponds to a non-linearity of the reception analog front end that is less than a non-linearity threshold; and
means for applying the second gain state based at least in part on obtaining the first non-linearity model associated with the transmitter.

19. The wireless device of claim 17, wherein the second gain state is associated with a second non-linearity of the reception analog front end, the second non-linearity is different than a first non-linearity associated with the first gain state.

20. A non-transitory computer-readable medium storing code for wireless communications, the code comprising instructions executable by one or more processors to:
receive one or more reference signals associated with a transmission antenna element of a wireless device;
perform a first non-linearity estimation to obtain a first non-linearity model associated with a transmitter of the wireless device based at least in part on receiving the one or more reference signals, the first non-linearity estimation is based at least in part on a first gain state; and
perform a second non-linearity estimation to obtain a second non-linearity model associated with a reception analog front end of the wireless device based at least in part on the first non-linearity model and a second gain state different than the first gain state, wherein the second non-linearity model is used for a linearization of one or more signals.
